(19) United States
(12) Patent Application Publication
(10) Pub. No.: US 2014/0099550 A1
(43) Pub. Date: Apr. 10, 2014

(54) SODIUM ION BATTERY SYSTEM

(71) Applicant: Hideki NAKAYAMA, Susono-shi (JP)

(72) Inventor: Hideki NAKAYAMA, Susono-shi (JP)

(73) Assignee: TOYOTA JIDOSHA KABUSHIKI KAISHA, Toyota-shi (JP)

(21) Appl. No.: 14/045,307

(22) Filed: Oct. 3, 2013

(30) Foreign Application Priority Data
Oct. 9, 2012 (JP) 2012-224471

(51) Int. Cl. H01M 2/34; H01M 10/054

(52) U.S. Cl. CPC H01M 2/34; H01M 10/054
USPC 429/221; 429/231.1; 429/231.2; 429/224

(57) ABSTRACT

The problem of the present invention is to provide a sodium ion battery system with high charge and discharge efficiency. The present invention solves the above-mentioned problem by providing a sodium ion battery system comprising a sodium ion battery and a charge control unit, wherein the anode active material is an active material having an Na₂Ti₆O₁₃ crystal phase, the anode active material layer contains a carbon material as a conductive material, and the above-mentioned charge control unit controls electric potential of the above-mentioned anode active material higher than electric potential in which an Na ion is irreversibly inserted into the above-mentioned carbon material.

### TECHNICAL FIELD

The present invention relates to a sodium ion battery system with high charge and discharge efficiency.

### BACKGROUND ART

A sodium ion battery is a battery such that an Na ion moves between a cathode and an anode. Na exists so abundantly as compared with Li that the sodium ion battery has the advantage that lower costs are easily intended as compared with a lithium ion battery. Generally, the sodium ion battery has a cathode active material layer containing a cathode active material, an anode active material layer containing an anode active material, and an electrolyte layer formed between the cathode active material layer and the anode active material layer.

Na₂Ti₆O₁₃ is known as the anode active material used for the sodium ion battery. For example, the sodium ion battery using Na₂Ti₆O₁₃ for the anode active material is disclosed in N. D. Trinh et al., “Synthesis, Characterization and Electrochemical Studies of Active Materials for Sodium Ion Batteries”, ECS Transactions, 35 (32) 91-98 (2011). Also, although not the sodium ion battery, the lithium ion battery using Na₂Ti₆O₁₃ for the anode active material is disclosed in J. C. Perez-Flores et al., “On the Mechanism of Lithium Insertion into A₂Ti₆O₁₃ (A=Na, Li)”, ECS Transactions, 41 (41) 195-206 (2012). The same description is given also in Prior Art of Japanese Patent Application Publication (JP-A) No. 2009-117259. Also, the sodium ion battery using lithium titanate (Li₄Ti₅O₁₂) for the anode active material is disclosed in JP-A No. 2011-049126. Also, it is disclosed in JP-A No. 2007-048682 that an active material and a carbon material are composited by a ball mill.

### SUMMARY OF INVENTION

### Technical Problem

The sodium ion battery using Na₂Ti₆O₁₃ for the anode active material is disclosed in N. D. Trinh et al., “Synthesis, Characterization and Electrochemical Studies of Active Materials for Sodium Ion Batteries”, ECS Transactions, 35 (32) 91-98 (2011). However, as shown in FIG. 8, the problem is that this battery is as low as approximately 27% in initial charge and discharge efficiency.

The present invention has been made in view of the above-mentioned actual circumstances, and the main object thereof is to provide a sodium ion battery system with high charge and discharge efficiency.

### Solution to Problem

In order to achieve the above-mentioned problems, the present invention provides a sodium ion battery system comprising: a sodium ion battery having a cathode active material layer containing a cathode active material, an anode active material layer containing an anode active material, and an electrolyte layer formed between the above-mentioned cathode active material layer and the above-mentioned anode active material layer; and a charge control unit, wherein the above-mentioned anode active material is an active material having an Na₂Ti₆O₁₃ crystal phase, the above-mentioned anode active material layer contains a carbon material as a conductive material, and the above-mentioned charge control unit controls electric potential of the above-mentioned anode active material higher than electric potential in which an Na ion is irreversibly inserted into the above-mentioned carbon material.

According to the present invention, electric potential of the anode active material is controlled so higher than predetermined electric potential that an irreversible reaction between the carbon material and the Na ion may be inhibited and the battery with high charge and discharge efficiency may be obtained.

In the above-mentioned invention, it is preferable that the above-mentioned carbon material is carbon black and the above-mentioned charge control unit controls the above-mentioned electric potential of the anode active material to 0.5 V (vs Na/Na⁺) or more.

In the above-mentioned invention, the crystallite size of the above-mentioned Na₂Ti₆O₁₃ crystal phase is preferably within a range of 190 Å to 520 Å. The reason therefor is to allow the improvement of charge and discharge efficiency to be further intended.

In the above-mentioned invention, part of Ti in the above-mentioned Na₂Ti₆O₁₃ crystal phase is preferably substituted with M (M is at least one of Fe, V, Mn, Mo, Al, Cr, Mg, Nb, W, Zr, Ta and Sn). The reason therefor is to allow the improvement of rate characteristic to be intended.

### Advantageous Effects of Invention

A sodium ion battery system of the present invention produces the effect such as to offer high charge and discharge efficiency.

### BRIEF DESCRIPTION OF DRAWINGS

FIG. 1 is a schematic cross-sectional view showing an example of a sodium ion battery in the present invention;

FIG. 2 is a schematic view showing an example of a sodium ion battery system of the present invention;

FIG. 3 is a flow chart showing a control method for a sodium ion battery system of the present invention;

FIG. 4 is a result of measuring XRD for an active material obtained in Example 1;

FIG. 5 is a result of a charge and discharge test of an evaluation battery in Example 1 and Comparative Example 1;

FIG. 6 is a result of a charge and discharge test of an evaluation battery obtained in Examples 2-1 to 2-5;

FIG. 7 is a result of a charge and discharge test of an evaluation battery obtained in Examples 2-6;

FIGS. 8A and 8B are results of a charge and discharge test of an evaluation battery obtained in Examples 1 and 3;

FIGS. 9A and 9B are results of a charge and discharge test (Na desorption capacity in charge and discharge current value) of an evaluation battery obtained in Examples 1 and 3; and

FIG. 10 is a result of a charge and discharge test (Na desorption capacity in charge and discharge current value) of an evaluation battery obtained in Examples 1 and 4.

### DESCRIPTION OF EMBODIMENTS

A sodium ion battery system of the present invention is hereinafter described in detail.

The sodium ion battery system of the present invention is a sodium ion battery system comprising: a sodium ion battery having a cathode active material layer containing a cathode active material, an anode active material layer containing an anode active material, and an electrolyte layer formed between the above-mentioned cathode active material layer and the above-mentioned anode active material layer; and a charge control unit, wherein the above-mentioned anode active material is an active material having an Na₂Ti₆O₁₃ crystal phase, the above-mentioned anode active material layer contains a carbon material as a conductive material, and the above-mentioned charge control unit controls electric potential of the above-mentioned anode active material higher than electric potential in which an Na ion is irreversibly inserted into the above-mentioned carbon material.

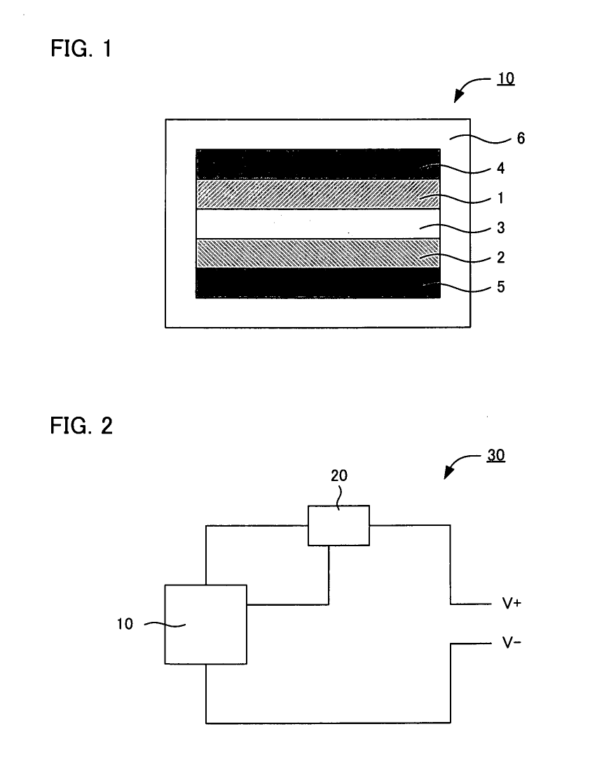

FIG. 1 is a schematic cross-sectional view showing an example of the sodium ion battery in the present invention. A sodium ion battery 10 shown in FIG. 1 has a cathode active material layer 1, an anode active material layer 2, an electrolyte layer 3 formed between the cathode active material layer 1 and the anode active material layer 2, a cathode current collector 4 for collecting the cathode active material layer 1, an anode current collector 5 for collecting the anode active material layer 2, and a battery case 6 for storing these members. In the present invention, the anode active material contained in the anode active material layer 2 is an active material having an Na₂Ti₆O₁₃ crystal phase, and the anode active material layer 2 contains a carbon material as a conductive material.

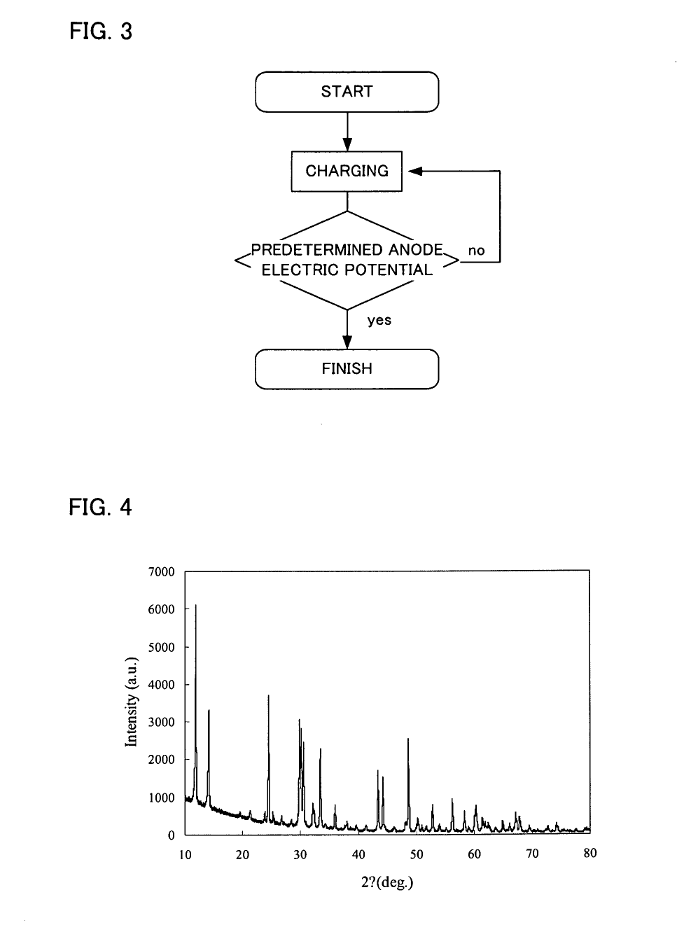

FIG. 2 is a schematic view showing an example of the sodium ion battery system of the present invention. As shown in FIG. 2, a sodium ion battery system 30 of the present invention comprises the sodium ion battery 10 and a charge control unit 20. The charge control unit 20 controls electric potential of the anode active material in the sodium ion battery 10 higher than electric potential (predetermined electric potential) in which an Na ion is irreversibly inserted into the carbon material. Na is inserted into the anode active material having an Na₂Ti₆O₁₃ crystal phase in charging, and electric potential of the anode active material (electric potential on the basis of Na) lowers. The charge control unit in the present invention controls so that electric potential of the anode active material does not become predetermined electric potential or less in charging. Specifically, as shown in FIG. 3, the charging is finished at a point of time when electric potential of the anode active material reaches predetermined electric potential.

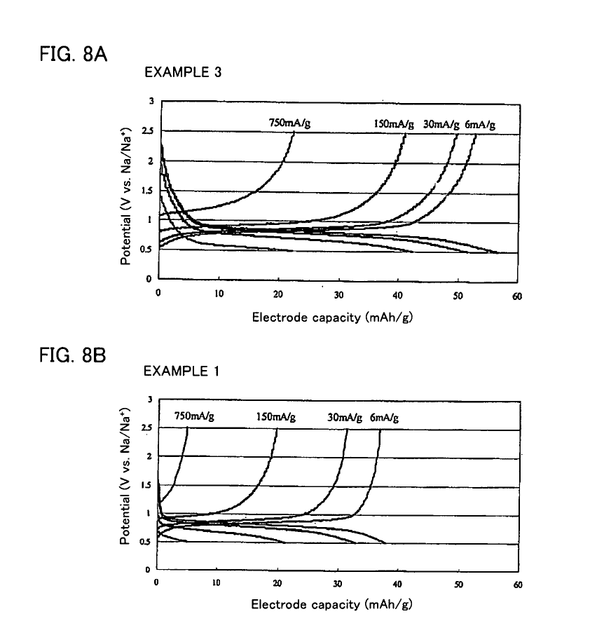

According to the present invention, electric potential of the anode active material is controlled so higher than predetermined electric potential that an irreversible reaction between the carbon material and the Na ion may be inhibited and the battery with high charge and discharge efficiency may be obtained. Here, the sodium ion battery using Na₂Ti₆O₁₃ for the anode active material is disclosed in N. D. Trinh et al., “Synthesis, Characterization and Electrochemical Studies of Active Materials for Sodium Ion Batteries”, ECS Transactions, (32) 91-98 (2011). However, as shown in FIG. 8, this battery is as low as approximately 27% in initial charge and discharge efficiency. In this literature, the point that film formation by liquid electrolyte decomposition is caused as a side reaction is described as the reason why charge and discharge efficiency is low. However, the inventors of the present invention have conceived that only the side reaction of film formation may not explain that charge and discharge efficiency lowers as much as this, and have conceived a possibility that another reason exists. Then, through earnest studies, they have found out that the irreversible reaction between the carbon material and the Na ion influences charge and discharge efficiency, and have confirmed that the controlling of electric potential of the anode active material so as not to become predetermined electric potential or less allows the improvement of charge and discharge efficiency to be intended.

The charge control unit in the present invention is characterized by controlling electric potential of the anode active material higher than electric potential in which an Na ion is irreversibly inserted into the carbon material. Here, “electric potential in which an Na ion is irreversibly inserted into the carbon material” signifies electric potential defined by the following measurement. First, a potential measuring cell having an electrode containing the target carbon material (a working electrode) and metallic Na (a counter electrode) is prepared. For example, a solution such that NaPF₆ was dissolved at a concentration of 1 mol/L in a solvent, in which EC (ethylene carbonate) and DEC (diethyl carbonate) were mixed by the same volume, is used for a liquid electrolyte. Next, a charge and discharge test is performed for the potential measuring cell at an environmental temperature of 25° C. and an electric current value of 6 mA/g. On this occasion, in the case where the lower limit electric potential of Na insertion (the lower limit of a measuring voltage range) in the first-time charge and discharge is regarded as V₁ and the lower limit electric potential of Na insertion in the second-time charge and discharge is regarded as V₂, the charge and discharge test Is performed on the conditions of satisfying V₁>V₂. Hereafter, charge and discharge are performed “n” times so as to satisfy Vₙ₋₁>Vₙ. Thus, when charge and discharge are performed while gradually lowering the lower limit electric potential of Na insertion, the lowering of charge and discharge efficiency resulting from the irreversible reaction between the carbon material and the Na ion may be confirmed in the m-time (1<m<n) charge and discharge. In the present invention, the electric potential at that time may be defined as electric potential in which an Na ion is irreversibly inserted into the carbon material. The lower limit electric potential of Na insertion is preferably lowered gradually in increments of 0.1 V, for example.

The sodium ion battery system of the present invention is hereinafter described in each constitution.

### 1. Sodium Ion Battery

The sodium ion battery in the present invention has at least an anode active material layer, a cathode active material layer, and an electrolyte layer.

### (1) Anode Active Material Layer

First, the anode active material layer in the present invention is described. The anode active material layer in the present invention is a layer containing the anode active material and the carbon material as a conductive material. Also, the anode active material layer may contain at least one of a binder and a solid electrolyte material in addition to the anode active material.

### (i) Anode Active Material

The anode active material in the present invention ordinarily has the Na₂Ti₆O₁₃ crystal phase. Incidentally, “Na₂Ti₆O₁₃ crystal phase” in the present invention is a concept of including such that part of Ti in the Na₂Ti₆O₁₃ crystal phase is substituted with another element, as described later. The presence of the Na₂Ti₆O₁₃ crystal phase may be confirmed by X-ray diffraction (XRD) measurement. For example, a CuKα ray may be used for the XRD measurement. The above-mentioned anode active material preferably has a peak in a position of 2θ=11.8°, 14.1°, 24.5°, 29.8°, 30.1 °, 30.5°, 32.2 °, 33.5°, 43.3 °, 44.3° and 48.6°, for example. Incidentally, these peak positions are actual measurement values obtained in the after-mentioned examples, and may fluctuate within a range of ±0.5°.

Also, the above-mentioned anode active material is preferably large in the ratio of the Na₂Ti₆O₁₃ crystal phase; specifically, the anode active material preferably contains the Na₂Ti₆O₁₃ crystal phase mainly. Here, “containing the Na₂Ti₆O₁₃ crystal phase mainly” signifies that the ratio of the Na₂Ti₆O₁₃ crystal phase is the largest in all crystal phases contained in the above-mentioned anode active material. The ratio of the Na₂Ti₆O₁₃ crystal phase contained in the above-mentioned anode active material is preferably 50 mol % or more, more preferably 60 mol % or more, and far more preferably 70 mol % or more. Also, the above-mentioned anode active material may be such as to be composed of only the Na₂Ti₆O₁₃ crystal phase (a single-phase active material). Incidentally, the ratio of the Na₂Ti₆O₁₃ crystal phase contained in the above-mentioned anode active material may be determined by a quantitative analysis method through X-ray diffraction (such as a quantification method by R-value and a Rietveld method).

Also, in the case where a peak intensity of 2θ=11.8° in the Na₂Ti₆O₁₃ crystal phase is regarded as I_{A} and a peak intensity of 2θ=25.2° in titanium oxide is regarded as I_{B}, the value of I_{B}/I_{A} is preferably 0.1 or less, more preferably 0.01 or less. Incidentally, I_{B} may be 0.

In the present invention, the crystallite size of the Na₂Ti₆O₁₃ crystal phase is preferably within the after-mentioned predetermined range. The reason therefor is to allow the improvement of charge and discharge efficiency to be further intended. Here, the inventors of the present invention have found out that the crystallite size of the Na₂Ti₆O₁₃ crystal phase influences charge and discharge efficiency in addition to the influence due to the above-mentioned irreversible reaction between the carbon material and the Na ion, and have confirmed that the determination of the crystallite size of the Na₂Ti₆O₁₃ crystal phase within the predetermined range allows the improvement of charge and discharge efficiency to be intended. In addition, as described later, they have found out that not merely the crystallite size of the Na₂Ti₆O₁₃ crystal phase but also the crystallinity of the carbon material used together with the anode active material influences charge and discharge efficiency, and have confirmed that the prescription of the crystallinity of the carbon material allows the improvement of charge and discharge efficiency to be intended.

The crystallite size of the Na₂Ti₆O₁₃ crystal phase is, for example, 190 Å or more, preferably 240 Å or more, and more preferably 250 Å or more. The reason therefor is that too small crystallite size of the Na₂Ti₆O₁₃ crystal phase brings a possibility of increasing the ratio of an unnecessary crystal phase (such as a crystal phase derived from a raw material). For example, in the case of synthesizing an active material with a small crystallite size of the Na₂Ti₆O₁₃ crystal phase by a solid-phase method, it is necessary to lower burning temperature and shorten burning time. As a result, there is a possibility of increasing the ratio of a crystal phase derived from a raw material such as titanium oxide, and a possibility of not allowing the improvement of charge and discharge efficiency to be sufficiently intended.

On the other hand, the crystallite size of the Na₂Ti₆O₁₃ crystal phase is ordinarily 520 Å or less, preferably 510 Å or less, and more preferably 500 Å or less. The reason therefor is that too large crystallite size of the Na₂Ti₆O₁₃ crystal phase brings a possibility of deteriorating charge and discharge efficiency. Examples of the reason for deteriorating charge and discharge efficiency include lengthening of an Na ion conduction path and an electron conduction path, and the decrease of a reaction active site in accordance with the decrease of a specific surface area. Incidentally, in N. D. Trinh et al., “Synthesis, Characterization and Electrochemical Studies of Active Materials for Sodium Ion Batteries”, ECS Transactions, 35 (32) 91-98 (2011), on the occasion of synthesizing Na₂Ti₆O₁₃, burning is performed at a temperature of 800° C. for one day, and thereafter burning is performed at a temperature of 930° C. for three days. These burning conditions are such that burning temperature is high and burning time is long as compared with the burning conditions in the after-mentioned examples. Thus, the crystallite size of the Na₂Ti₆O₁₃ is larger than the crystallite size in the present invention.

Also, the crystallite size of the Na₂Ti₆O₁₃ crystal phase may be calculated from a half-value width of a peak obtained by the XRD measurement. For example, the crystallite size may be calculated by the Scherrer's formula with the use of full width at half maximum (FWHM) of the above-mentioned peak of 2θ=11.8°.

D=Kλ/(β cos θ)

K: Scherrer constant, λ: wavelength, β: spread of diffraction line by size of crystallite, θ: angle of diffraction 2θ/θ

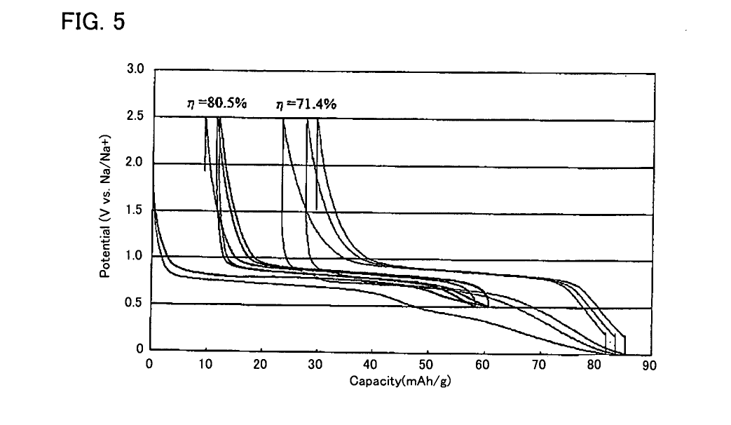

Incidentally, it is difficult to accurately calculate the crystallite size of the Na₂Ti₆O₁₃ from the XRD pattern shown in FIG. 5 of N. D. Trinh et al., “Synthesis, Characterization and Electrochemical Studies of Active Materials for Sodium Ion Batteries”, ECS Transactions, 35 (32) 91-98 (2011), but the peak is so remarkable that the crystallite size is guessed to be approximately a little less than 1 μm.

Also, in the present invention, part of Ti in the Na₂Ti₆O₁₃ crystal phase may be substituted with M (M is at least one of Fe, V, Mn, Mo, Al, Cr, Mg, Nb, W, Zr, Ta and Sn). The substitution of Ti with M allows the improvement of rate characteristic to be intended. The reason why rate characteristic improves is not necessarily clear but guessed to be that the substitution of part of Ti with M improves electron conductivity of an active material. Incidentally, the ionic radius of an element represented by M is close to the ionic radius of Ti. M is preferably at least one of Fe, V, Mn and W, and particularly preferably Fe. Also, M preferably has a valence number different from the valence number (quadrivalence) of Ti. Specifically, M preferably has a valence number of trivalence or pentavalence. The reason therefor is that the introduction of M different in valence number from Ti brings an effect such as an n-type semiconductor or a p-type semiconductor to easily improve electron conductivity.

The substituted amount of M (M/(M+Ti)) is not particularly limited but is, for example, preferably 0.1 at % or more, and more preferably 0.5 at % or more. The reason therefor is that too small substituted amount of M brings a possibility of not sufficiently improving rate characteristic. On the other hand, the substituted amount of M (M/(M+Ti)) is, for example, preferably 20 at % or less, and more preferably 10 at % or less. The reason therefor is that too large substituted amount of M brings a possibility of changing the crystal structure. Incidentally, the substituted amount of M may be measured by ICP, for example.

With regard to the above-mentioned anode active material, Na insertion electric potential into metallic Na is preferably 1.0 V or less, and more preferably within a range of 0.5 V to 1.0 V. The reason therefor is that too low Na insertion electric potential brings a possibility that metallic Na may not sufficiently be inhibited from precipitating, whereas too high Na insertion electric potential brings a possibility that battery voltage decreases. In the present invention, Na insertion electric potential of the above-mentioned anode active material may be determined by a cyclic voltammetry (CV) method.

The above-mentioned anode active material is preferably composited with a conductive material. The reason therefor is to allow the improvement of rate characteristic to be intended. The conductive material to be composited is not particularly limited if the conductive material is such as to have desired electron conductivity, but examples thereof include a carbon material and a metallic material, and preferably a carbon material among them. Examples of the carbon material include carbon black such as acetylene black, Ketjen Black, furnace black and thermal black; carbon fiber such as VGCF; graphite; hard carbon; and coke. Examples of the metallic material include Fe, Cu, Ni and Al. “The anode active material and the conductive material are composited” ordinarily signifies a state obtained by subjecting both of them to mechanochemical treatment. Examples thereof include a state such that both of them are dispersed so as to be closely stuck to each other in a nano order, and a state such that one is dispersed so as to be closely stuck to the surface of the other in a nano order. Incidentally, a chemical bond may exist between both of them. To be composited may be confirmed by SEM observation, TEM observation, TEM-EELS method and X-ray absorption fine structure (XAFS), for example. Also, examples of the mechanochemical treatment include treatment such as to allow mechanical energy, such as a ball mill. Also, a commercially available composite device (such as Nobilta™ manufactured by Hosokawa Micron Corp.) may be used.

Also, in the case where the above-mentioned anode active material is composited with the conductive material, the ratio of the composited conductive material is, for example, preferably within a range of 1% by weight to 30% by weight, and more preferably within a range of 5% by weight to 20% by weight. The reason therefor is that too small ratio of the composited conductive material brings a possibility of not allowing the improvement of rate characteristic to be sufficiently intended, whereas too large ratio of the composited conductive material brings a possibility of relatively decreasing the amount of the active material to reduce the capacity. In the case where the composited conductive material is the carbon material, crystallinity of the carbon material is preferably high. Specifically, as described later, the carbon material is preferably composited so that interlayer distance d002 or D/G ratio becomes a predetermined value.

The shape of the above-mentioned anode active material is preferably a particulate shape, for example. Also, the average particle diameter thereof (D₅₀) is preferably, for example within a range of 1 nm to 100 μm, and above all within a range of 10 nm to 30 μm.

Also, a method for producing the above-mentioned anode active material is not particularly limited if the method is such as to allow the above-mentioned active material, but examples thereof include a solid-phase method. Specific examples of the solid-phase method include a method for preparing a raw material composition in which an Na source (such as sodium carbonate) and a Ti source (such as titanium oxide) are mixed at a predetermined ratio to burn the raw material composition. Also, the crystallite size may be controlled by adjusting burning temperature and burning time, for example. In the case where burning temperature is high and burning time is long, the crystallite size tends to enlarge. The burning temperature is, for example, preferably within a range of 700° C. to 900° C., and more preferably within a range of 750° C. to 850° C. The reason therefor is that too low burning temperature brings a possibility of not causing a solid-phase reaction, whereas too high burning temperature brings a possibility of producing an unnecessary crystal phase. The burning time is, for example, preferably within a range of 20 hours to 80 hours, and more preferably within a range of 40 hours to 60 hours. The atmosphere of burning is not particularly limited but may be an atmosphere in which oxygen exists, an inert gas atmosphere, or a decompression (vacuum) atmosphere.

(ii) Conductive material

The anode active material layer in the present invention ordinarily contains the conductive material. The conductive material may be such as to be composited with the above-mentioned anode active material, such as not to be composited but to exist in a mixed state with the anode active material in the anode active material layer, or both of them. In the present invention, at least the carbon material is used as the above-mentioned conductive material. The conductive material is not particularly limited if the conductive material is such as to have desired electron conductivity, but is the same as the contents described in the above-mentioned “(i) Anode active material”. Above all, in the present invention, the crystallinity of the carbon material is preferably high. The reason therefor is that crystallinity of the carbon material is so high that an Na ion is inserted into the carbon material with difficulty and irreversible capacitance due to Na ion insertion may be decreased. As a result, the improvement of charge and discharge efficiency may be further intended. The crystallinity of the carbon material may be prescribed by interlayer distance d002 and D/G ratio, for example.

With regard to the above-mentioned carbon material, the interlayer distance d002 is, for example, preferably 3.54 Å or less, more preferably 3.50 Å or less, and far more preferably 3.40 Å or less. The reason therefor is to allow the carbon material with high crystallinity. On the other hand, the interlayer distance d002 is ordinarily 3.36 Å or more. The interlayer distance d002 signifies interplanar spacing of (002) plane in the carbon material, and specifically corresponds to a distance between graphene layers. The interlayer distance d002 may be measured from a peak obtained by an X-ray diffraction (XRD) method with the use of a CuKα ray, for example.

With regard to the above-mentioned carbon material, the D/G ratio measured by Raman spectroscopy measurement is, for example, preferably 0.90 or less, more preferably 0.80 or less, far more preferably 0.50 or less, and particularly preferably 0.20 or less. The reason therefor is to allow the carbon material with high crystallinity. The D/G ratio signifies peak intensity of D-band derived from a defect structure in the vicinity of 1350 cm⁻¹ with respect to peak intensity of G-band derived from a graphite structure in the vicinity of 1590 cm⁻¹, which are observed in Raman spectroscopy measurement (a wavelength of 532 nm).

(iii) Anode Active Material Layer

The anode active material layer in the present invention may contain the binder. The binder is not particularly limited if the binder is such as to be stable chemically and electrically, but examples thereof include fluorine-based binders such as polyvinylidene fluoride (PVDF) and polytetrafluoroethylene (PTFE), rubber-based binders such as styrene-butadiene rubber, olefin-based binders such as polypropylene (PP) and polyethylene (PE), and cellulose-based binders such as carboxymethyl cellulose (CMC). Also, the solid electrolyte material is not particularly limited if the material is such as to have desired ion conductivity, but examples thereof include an oxide based solid electrolyte material and a sulfide solid electrolyte material. Incidentally, the solid electrolyte material is described in detail in the after-mentioned “(3). Electrolyte layer”.

The content of the anode active material in the anode active material layer is preferably larger from the viewpoint of capacity; preferably, for example within a range of 60% by weight to 99% by weight, above all within a range of 70% by weight to 95% by weight. Also, the content of the conductive material is preferably smaller if the material may secure desired electron conductivity; preferably, for example within a range of 5% by weight to 80% by weight, and above all within a range of 10% by weight to 40% by weight. The reason therefor is that too small content of the conductive material brings a possibility of not allowing sufficient electron conductivity, whereas too large content of the conductive material brings a possibility of relatively decreasing the amount of the active material to reduce the capacity. Also, the content of the binder is preferably smaller if the binder may stably fix the anode active material; preferably, for example within a range of 1% by weight to 40% by weight. The reason therefor is that too small content of the binder brings a possibility of not allowing sufficient binding property, whereas too large content of the binder brings a possibility of relatively decreasing the amount of the active material to reduce the capacity. Also, the content of the solid electrolyte material is preferably smaller if the material may secure desired ion conductivity; preferably, for example within a range of 1% by weight to 40% by weight. The reason therefor is that too small content of the solid electrolyte material brings a possibility of not allowing sufficient ion conductivity, whereas too large content of the solid electrolyte material brings a possibility of relatively decreasing the amount of the active material to reduce the capacity.

Also, the thickness of the anode active material layer varies greatly with the constitution of the battery, and is preferably within a range of 0.1 μm to 1,000 μm, for example.

### (2) Cathode Active Material Layer

Next, the cathode active material layer in the present invention is described. The cathode active material layer in the present invention is a layer containing at least the cathode active material. Also, the cathode active material layer may contain at least one of a conductive material, a binder and a solid electrolyte material in addition to the cathode active material.

Examples of the cathode active material include bed type active materials, spinel type active materials, and olivine type active materials. Specific examples of the cathode active material include NaFeO₂, NaNiO₂, NaCoO₂, NaMnO₂, NaVO₂, Na (NiₓMn₁₋ₓ)O₂ (0<X<1), Na (FeₓMn₁₋ₓ)O₂ (0<X<1), NaVPO₄F, Na₂FePO₄F, and Na₃V₂(PO₄)₃.

The shape of the cathode active material is preferably a particulate shape. Also, the average particle diameter of the cathode active material (D₅₀) is preferably, for example within a range of 1 nm to 100 μm, and above all within a range of 10 nm to 30 μm. The content of the cathode active material in the cathode active material layer is preferably larger from the viewpoint of capacity; preferably, for example within a range of 60% by weight to 99% by weight, and above all within a range of 70% by weight to 95% by weight. Incidentally, the kinds and content of the conductive material, the binder and the solid electrolyte material used for the cathode active material layer are the same as the contents described in the above-mentioned anode active material layer; therefore, the description herein is omitted. Also, the thickness of the cathode active material layer varies greatly with the constitution of the battery, and is preferably within a range of 0.1 μm to 1,000 μm, for example.

### (3) Electrolyte Layer

Next, the electrolyte layer in the present invention is described. The electrolyte layer in the present invention is a layer formed between the above-mentioned cathode active material layer and the above-mentioned anode active material layer. Ion conduction between the cathode active material and the anode active material is performed through the electrolyte contained in the electrolyte layer. The form of the electrolyte layer is not particularly limited but examples thereof include a liquid electrolyte layer, a gel electrolyte layer and a solid electrolyte layer.

The liquid electrolyte layer is ordinarily a layer obtained by using a nonaqueous liquid electrolyte. The nonaqueous liquid electrolyte ordinarily contains a sodium salt and a nonaqueous solvent. Examples of the sodium salt include inorganic sodium salts such as NaPF₆, NaBF₄, NaClO₄ and NaAsF₆; and organic sodium salts such as NaCF₃SO₃, NaN(CF₃SO₂)₂, NaN(C₂F₅SO₂)₂, NaN(FSO₂)₂ and NaC(CF₃SO₂)₃. The nonaqueous solvent is not particularly limited if the solvent is such as to dissolve the sodium salt. Examples of the high-dielectric-constant solvent include cyclic ester (cyclic carbonate) such as ethylene carbonate (EC), propylene carbonate (PC) and butylene carbonate (BC), γ-butyrolactone, sulfolane, N-methylpyrrolidone (NMP), and 1,3-dimethyl-2-imidazolidinone (DMI). On the other hand, examples of the low-viscosity solvent include chain ester (chain carbonate) such as dimethyl carbonate (DMC), diethyl carbonate (DEC) and ethyl methyl carbonate (EMC), acetate such as methyl acetate and ethyl acetate, and ether such as 2-methyltetrahydrofuran. A mixed solvent such that the high-dielectric-constant solvent and the low-viscosity solvent are mixed may be used. The concentration of the sodium salt in the nonaqueous liquid electrolyte is, for example, within a range of 0.3 mol/L to 5 mol/L, and preferably within a range of 0.8 mol/L to 1.5 mol/L. The reason therefor is that too low concentration of the sodium salt brings a possibility of causing capacity reduction during high rate, whereas too high concentration of the sodium salt brings a possibility of increasing viscosity to cause capacity reduction at low temperature. Incidentally, in the present invention, a low-volatile liquid such as an ionic liquid may be used as the nonaqueous liquid electrolyte.

The gel electrolyte layer may be obtained by adding and gelating a polymer to a nonaqueous liquid electrolyte, for example. Specifically, gelation may be performed by adding polymers such as polyethylene oxide (PEO), polyacrylonitrile (PAN) or polymethyl methacrylate (PMMA) to a nonaqueous liquid electrolyte.

The solid electrolyte layer is a layer obtained by using the solid electrolyte material. The solid electrolyte material is not particularly limited if the material is such as to have Na ion conductivity, but examples thereof include an oxide based solid electrolyte material and a sulfide solid electrolyte material. Examples of the oxide based solid electrolyte material include Na₃Zr₂Si₂PO₁₂ and β-alumina solid electrolyte (such as Na₂O-11Al₂O₃). Examples of the sulfide solid electrolyte material include Na₂S—P₂S₅.

The solid electrolyte material in the present invention may be amorphous or crystalline. Also, the shape of the solid electrolyte material is preferably a particulate shape. Also, the average particle diameter of the solid electrolyte material (D₅₀) is preferably, for example within a range of 1 nm to 100 μm, and above all within a range of 10 nm to 30 μm.

The thickness of the electrolyte layer varies greatly with kinds of the electrolyte and constitutions of the battery, and is preferably, for example within a range of 0.1 μm to 1,000 μm, and above all within a range of 0.1 μm to 300 μm.

### (4) Other Constitutions

The sodium ion battery in the present invention has at least the above-mentioned anode active material layer, cathode active material layer and electrolyte layer, ordinarily further having a cathode current collector for collecting the cathode active material layer and an anode current collector for collecting the anode active material layer. Examples of a material for the cathode current collector include SUS, aluminum, nickel, iron, titanium and carbon. On the other hand, examples of a material for the anode current collector include SUS, copper, nickel and carbon. Also, examples of the shape of the cathode current collector and the anode current collector include a foil shape, a mesh shape and a porous shape.

The sodium ion battery in the present invention may have a separator between the cathode active material layer and the anode active material layer. The reason therefor is to allow the battery with higher safety. Examples of a material for the separator include porous membranes such as polyethylene (PE), polypropylene (PP), cellulose and polyvinylidene fluoride; and nonwoven fabrics such as resin nonwoven fabric and glass fiber nonwoven fabric. Also, the separator may be a single-layer structure (such as PE and PP) or a laminated structure (such as PP/PE/PP). Also, a battery case of a general battery may be used for a battery case used for the present invention. Examples of the battery case include a battery case made of SUS.

### (5) Sodium Ion Battery

The sodium ion battery in the present invention is not particularly limited if the battery is such as to have the above-mentioned cathode active material layer, anode active material layer and electrolyte layer. Also, the sodium ion battery in the present invention may be a battery in which the electrolyte layer is the solid electrolyte layer, a battery in which the electrolyte layer is the liquid electrolyte layer, or a battery in which the electrolyte layer is the gel electrolyte layer. In addition, the sodium ion battery in the present invention may be a primary battery or a secondary battery, and preferably a secondary battery among them. The reason therefor is to be repeatedly charged and discharged and be useful as a car-mounted battery, for example. Also, examples of the shape of the sodium ion battery in the present invention include a coin shape, a laminate shape, a cylindrical shape and a rectangular shape. Also, a producing method for the sodium ion battery is not particularly limited but is the same as a producing method for a general sodium ion battery.

### 2. Charge Control Unit

The charge control unit in the present invention controls electric potential of the above-mentioned anode active material higher than electric potential in which an Na ion is irreversibly inserted into the above-mentioned carbon material. Incidentally, a measuring method for this electric potential is as described above. On the other hand, in order to operate the sodium ion battery, the charge control unit in the present invention controls electric potential of the anode active material lower than Na insertion electric potential of the anode active material.

The charge control unit in the present invention is not particularly limited if the charge control unit is such as to control electric potential of the anode active material higher than electric potential in which an Na ion is irreversibly inserted into the carbon material, but the lower limit electric potential to be controlled is properly determined in accordance with kinds of the carbon material. For example, in the case where the carbon material is carbon black typified by acetylene black, the charge control unit controls electric potential of the anode active material to, for example, preferably 0.5 V (vs Na/Na⁺) or more, more preferably 0.6 V (vs Na/Na⁺) or more. The carbon black is comparatively so low in crystallinity that electric potential in which an Na ion is irreversibly inserted into the carbon material is high. The electric potential is comparatively so close to Na insertion electric potential of the anode active material having the Na₂Ti₆O₁₃ crystal phase that the problem is easily caused. Also, it is conceived that the influence of the anode active material having the Na₂Ti₆O₁₃ crystal phase brings a possibility of promoting the irreversible reaction between the carbon black and the Na ion.

The constitution of the charge control unit is not particularly limited but examples thereof include such as to be composed of a measuring section for measuring the electric potential of the anode active material on the basis of Na, and a switch section for cutting off the electric current in accordance with the electric potential of the anode active material.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### EXAMPLES

The present invention is described more specifically while showing examples hereinafter.

### Example 1

### (Synthesis of Active Material)

Sodium carbonate (Na₂CO₃) and titanium oxide (anatase, TiO₂) were weighed as starting materials at a molar ratio of Na₂CO₃:TiO₂=1:6, and mixed in ethanol. Next, the ethanol was removed by drying, and the solution was molded into pellets, which were burned in a muffle furnace on the conditions of 800° C. and 60 hours. Thus, an active material having an Na₂Ti₆O₁₃ crystal phase was obtained.

### (Production of Evaluation Battery)

An evaluation battery using the obtained active material was produced. First, the obtained active material, a conductive material (acetylene black, interlayer distance d002=3.54 Å, D/G ratio=0.87), and a binder (polyvinylidene fluoride, PVDF) were mixed and kneaded at a weight ratio of active material:conductive material:binder=85:10:5 to thereby obtain a paste. Next, the obtained paste was coated on a copper foil by a doctor blade, dried and pressed to thereby obtain a test electrode with a thickness of 20 μm.

Thereafter, a CR2032-type coin cell was used, the above-mentioned test electrode was used as a working electrode, metallic Na was used as a counter electrode, and a porous separator of polyethylene/polypropylene/polyethylene (a thickness of 25 μm) was used as a separator. A solution such that NaPF₆ was dissolved at a concentration of 1 mol/L in a solvent, in which EC (ethylene carbonate) and DEC (diethyl carbonate) were mixed by the same volume, was used for a liquid electrolyte. Thus, an evaluation battery was obtained.

### Evaluation 1

### (Evaluation of Carbon Material)

The electric potential in which an Na ion is irreversibly inserted into the carbon material was measured for acetylene black used in Example 1. First, a potential measuring cell having an electrode containing the target carbon material (a working electrode) and metallic Na (a counter electrode) was prepared. A solution such that NaPF₆ was dissolved at a concentration of 1 mol/L in a solvent, in which EC (ethylene carbonate) and DEC (diethyl carbonate) were mixed by the same volume, was used for a liquid electrolyte. Next, a charge and discharge test was performed for the potential measuring cell at an environmental temperature of 25° C. and an electric current value of 6 mA/g. On this occasion, the lower limit electric potential of Na insertion was gradually lowered from 0.7 V in increments of 0.1 V. As a result, the lowering of charge and discharge efficiency resulting from the irreversible reaction between the carbon material and the Na ion was confirmed at a point of time of 0.4 V. Thus, electric potential in which an Na ion is irreversibly inserted into the carbon material was determined at 0.4 V.

### (XRD Measurement)

X-ray diffraction (XRD) measurement by using a CuKα ray was performed for the active material obtained in Example 1. The results are shown in FIG. 4. As shown in FIG. 4, in Example 1, a typical peak which exhibits the Na₂Ti₆O₁₃ crystal phase was confirmed in a position of 2θ=11.8°, 14.1°, 24.5°, 29.8°, 30.1°, 30.5°, 32.2°, 33.5°, 43.3°, 44.3° and 48.6°. Also, in the case where a peak intensity of 2θ=11.8° in the Na₂Ti₆O₁₃ crystal phase is regarded as I_{A} and a peak intensity of 2θ=25.2° in titanium oxide is regarded as I_{B} the value of I_{B}/I_{A} was 0.08.

### (Charge and Discharge Test)

A charge and discharge test was performed for the evaluation battery obtained in Example 1. Specifically, the test was performed on the conditions of an environmental temperature of 25° C., an electric current value of 6 mA/g and a voltage range of 0.5 V to 2.5 V to measure the initial charge and discharge efficiency. On the other hand, as Comparative Example 1, the initial charge and discharge efficiency was measured in the same manner as Example 1 except for modifying the voltage range into 10 mV to 2.5 V. The results are shown in Table 1 and FIG. 5.

TABLE 1

| | Lower Limit Electric | Charge and |
|---|---|---|
| | Potential of Na | Dishcharge |
| | Insertion | Efficiency |
| | (V vs. Na/Na+) | (%) |
| Example 1 | 0.5 | 80.5 |
| Comparative Example 1 | 0.01 | 71.4 |

As shown in Table 1 and FIG. 5, the controlling of electric potential of the active material having the Na₂Ti₆O₁₃ crystal phase to 0.5 V (vs Na/Na⁺) or more allowed the improvement of charge and discharge efficiency to be confirmed.

### Example 2-1

### (Synthesis of Active Material)

Sodium carbonate (Na₂CO₃) and titanium oxide (anatase, TiO₂) were weighed as starting materials at a molar ratio of Na₂CO₃:TiO₂=1:6, and mixed in ethanol. Next, the ethanol was removed by drying, and the solution was molded into pellets, which were burned in a muffle furnace on the conditions of 700° C. and 60 hours. Thus, an active material having an Na₂Ti₆O₁₃ crystal phase was obtained. An evaluation battery was obtained in the same manner as Example 1 except for using the obtained active material.

### Example 2-2

An active material was obtained in the same manner as Example 2-1 except for burning on the conditions of 800° C. and 30 hours. In addition, an evaluation battery was obtained in the same manner as Example 2-1 except for using the obtained active material.

### Example 2-3

An active material was obtained in the same manner as Example 2-1 except for burning on the conditions of 800° C. and 60 hours. In addition, an evaluation battery was obtained in the same manner as Example 2-1 except for using the obtained active material. Incidentally, the conditions of Example 2-3 are the same as the above-mentioned Example 1.

### Example 2-4

An active material was obtained in the same manner as Example 2-1 except for burning on the conditions of 900° C. and 30 hours. In addition, an evaluation battery was obtained in the same manner as Example 2-1 except for using the obtained active material.

### Example 2-5

An active material was obtained in the same manner as Example 2-1 except for burning on the conditions of 900° C. and 60 hours. In addition, an evaluation battery was obtained in the same manner as Example 2-1 except for using the obtained active material.

### Evaluation 2

### (Charge and Discharge Test)

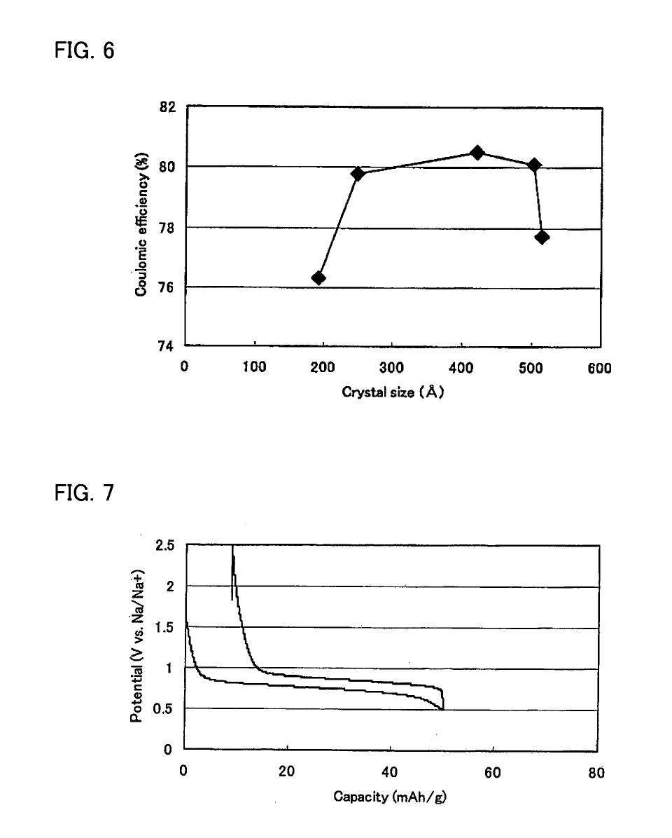

A charge and discharge test was performed for the evaluation battery obtained in Examples 2-1 to 2-5. Specifically, the test was performed on the conditions of an environmental temperature of 25° C., an electric current value of 6 mA/g and a voltage range of 0.5 V to 2.5 V to measure the initial charge and discharge efficiency. The results are shown in Table 2 and FIG. 6.

TABLE 2

| | | Charge and |
|---|---|---|
| | Crystallite | Discharge |
| | Size | Efficiency |
| | (Å) | (%) |
| Example 2-1 | 192 | 76.3 |
| Example 2-2 | 248 | 79.8 |
| Example 2-3 | 419 | 80.5 |
| Example 2-4 | 501 | 80.1 |
| Example 2-5 | 513 | 77.7 |

As shown in Table 2 and FIG. 6, it became clear that charge and discharge efficiency improved in the case where the crystallite size was within a range of 190 Å to 520 Å. In particular, a charge and discharge efficiency of more than 80% was realized in the case where the crystallite size was within a range of 250 Å to 500 Å.

### Example 2-6

An evaluation battery was obtained in the same manner as Example 2-3 except for using graphite (interlayer distance d002=3.36 Å, D/G ratio=0.12) as a conductive material.

### Example 2-7

An evaluation battery was obtained in the same manner as Example 2-3 except for using VGCF (interlayer distance d002=3.37 Å, D/G ratio=0.07) as a conductive material.

### Evaluation 3

### (Charge and Discharge Test)

A charge and discharge test was performed for the evaluation battery obtained in Examples 2-3, 2-6 and 2-7. Specifically, the test was performed on the conditions of an environmental temperature of 25° C., an electric current value of 6 mA/g and a voltage range of 0.5 V to 2.5 V to measure the initial charge and discharge efficiency. The results are shown in Table 3.

TABLE 3

| | | | | CHARGE AND |
|---|---|---|---|---|
| | | | | DISCHARGE |
| | | d002 | D/G | EFFICIENCY |
| | Conductive Material | (Å) | RATIO | (%) |
| Example 2-3 | Acetylene Black | 3.54 | 0.87 | 80.5 |
| Example 2-6 | Graphite | 3.36 | 0.12 | 82.5 |
| Example 2-7 | VGCF | 3.37 | 0.07 | 82.4 |

As shown in Table 3, it became clear that charge and discharge efficiency improved further in the case where the crystallinity of the conductive material was higher (interlayer distance d002 was smaller and D/G ratio was smaller). FIG. 7 is a result of Example 2-6 in which charge and discharge efficiency was the highest.

### Example 3

The active material obtained in Example 1 and acetylene black (interlayer distance d002=3.54 Å, D/G ratio=0.87) were weighed at a weight ratio of active material:acetylene black=90:10, and a mixture thereof was put in a pot made of ZrO₂ and subjected to a ball milling process (180 rpm×24 hours). Thus, the active material with which the acetylene black was composited was obtained. An evaluation battery was obtained in the same manner as Example 1 except for using the obtained composited active material.

### Evaluation 4

### (Charge and Discharge Test)

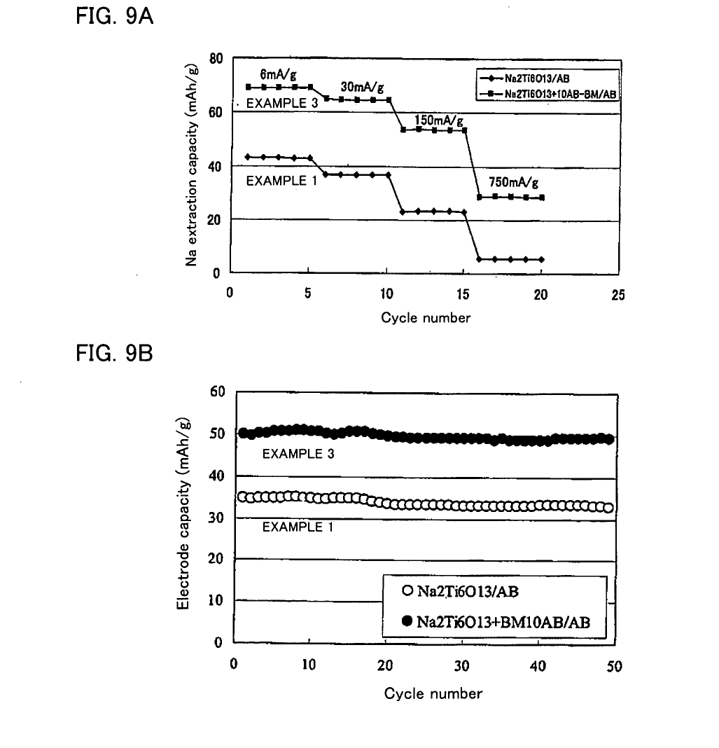

A charge and discharge test was performed for the evaluation battery obtained in Examples 1 and 3. Specifically, the test was performed on the conditions of an environmental temperature of 25° C. and a voltage range of 0.5 V to 2.5 V. The electric current value was changed to 6 mA/g, 30 mA/g, 150 mA/g and 750 mA/g. The results are shown in FIGS. 8A, 8B, 9A and 9B. As shown in FIGS. 8A, 8B, 9A and 9B, it may be confirmed that Example 3 was excellent in capacity, rate characteristic and cycling characteristic as compared with Example 1.

### Example 4

Sodium carbonate (Na₂CO₃), titanium oxide (anatase, TiO₂) and iron oxide (Fe₂O₃) were weighed as starting materials at a molar ratio of Na₂CO₃:TiO₂:Fe₂O₃=1:5.94:0.03, and mixed in ethanol. Incidentally, the substituted amount of Fe (Fe/(Fe+Ti)) is 1 at %. Next, the ethanol was removed by drying, and the solution was molded into pellets, which were burned in a muffle furnace on the conditions of 800° C. and 60 hours. Thus, an active material having a crystal phase (Na₂Ti₆₋ₓ,FeₓO₁₃, x=0.06) such that part of Ti in Na₂Ti₆O₁₃ was substituted with Fe was obtained. An evaluation battery was obtained in the same manner as Example 1 except for using the obtained active material.

### Evaluation 5

### (Charge and Discharge Test)

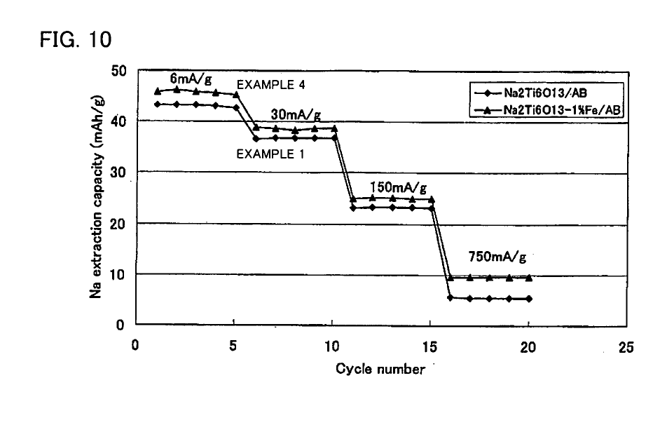

A charge and discharge test was performed for the evaluation battery obtained in Examples 1 and 4. Specifically, the test was performed on the conditions of an environmental temperature of 25° C. and a voltage range of 0.5 V to 2.5 V. The electric current value was changed to 6 mA/g, 30 mA/g, 150 mA/g and 750 mA/g. The results are shown in FIG. 10. As shown in FIG. 10, in Example 4, capacity increased in all electric current values as compared with Example 1. In addition, when the electric current value was as large as 750 mA/g, the increasing rate of capacity with respect to Example 1 was large in Example 4. Thus, it may be confirmed that the substitution of part of Ti in Na₂Ti₆O₁₃ with Fe caused capacity and rate characteristic to improve.

### REFERENCE SIGNS LIST

1 . . . cathode active material layer
2 . . . anode active material layer
3 . . . electrolyte layer
4 . . . cathode current collector
5 . . . anode current collector
6 . . . battery case
10 . . . sodium ion battery
20 . . . charge control unit
30 . . . sodium ion battery system

What is claimed is:

1. A sodium ion battery system comprising:
a sodium ion battery having a cathode active material layer containing a cathode active material, an anode active material layer containing an anode active material, and an electrolyte layer formed between the cathode active material layer and the anode active material layer; and
a charge control unit,
wherein the anode active material is an active material having an Na₂Ti₆O₁₃ crystal phase,
the anode active material layer contains a carbon material as a conductive material, and
the charge control unit controls electric potential of the anode active material higher than electric potential in which an Na ion is irreversibly inserted into the carbon material.

2. The sodium ion battery system according to claim 1, wherein the carbon material is carbon black, and
the charge control unit controls the electric potential of the anode active material to 0.5 V (vs Na/Na⁺) or more.

3. The sodium ion battery system according to claim 1, wherein a crystallite size of the Na₂Ti₆O₁₃ crystal phase is within a range of 190 Å to 520 Å.

4. The sodium ion battery system according to claim 1, wherein a part of Ti in the Na₂Ti₆O₁₃ crystal phase is substituted with M (M is at least one of Fe, V, Mn, Mo, Al, Cr, Mg, Nb, W, Zr, Ta and Sn).
